(19) United States
(12) Patent Application Publication
(10) Pub. No.: US 2017/0241799 A1
(43) Pub. Date: Aug. 24, 2017

(54) SYSTEMS AND METHODS TO COMPENSATE FOR GYROSCOPE OFFSET

(71) Applicant: InvenSense, Inc., San Jose, CA (US)

(72) Inventor: Mamdouh Kamal Yanni, San Ramon, CA (US)

(21) Appl. No.: 15/049,350

(22) Filed: Feb. 22, 2016

(51) Int. Cl. G01C 25/00

(52) U.S. Cl. CPC G01C 25/005

(57) ABSTRACT

A gyroscope signal may be compensated for offset by performing a low frequency adaptive noise cancellation process. Noise corresponding to user dynamics may be reduced by performing a motion sensor based adaptive noise cancellation process. Further, noise corresponding to vibratory motion of the portable device may be reduced by applying a discrete wavelet transform function.

### FIELD OF THE PRESENT DISCLOSURE

This disclosure generally relates to the calibration of sensors and more specifically to the compensation of offset and other noise in a gyroscope signal.

### BACKGROUND

The development of microelectromechanical systems (MEMS) has enabled the incorporation of a wide variety of sensors into portable devices, such as cell phones, laptops, tablets, gaming devices and other portable, electronic devices. Although some embodiments are associated with a user, such portable devices may also include vehicles, such as drones, or other devices capable of relative motion. Notably, information from motion sensors such as gyroscopes that measure angular velocity along one or more orthogonal axes may be used to determine the orientation or change in relative orientation of a device incorporating the gyroscope for use as a user input, to determine positional or navigational information for the device, or for other suitable purposes.

However, due to the nature of electronics and mechanics, including their relative size and materials and methods of construction, such MEMS inertial instruments are relatively sensitive to ambient temperature and other environmental factors and therefore may be relatively unstable. MEMS-based sensors may be prone to having offset, or bias, errors. Offset is the non-zero output of a gyroscope when motionless. The gyroscope may be subject to other errors, including noise from vibration or periodic motion associated with user dynamics. These errors may drift or change due to temperature, humidity, time, assembly stress and other changes in peripheral conditions. In turn, if the errors are not properly compensated, the quality of sensor data the quality of the sensor data may be degraded and complicate the use of the gyroscope information. For example, a sensor fusion process used to combine the gyroscope output with another motion sensor, such as an accelerometer, may estimate a position or orientation of the device. Parameters such as attitude (e.g., pitch, roll, and yaw) may represent the orientation of the device and be used in combination with dead reckoning techniques to determine position. Accordingly, integration of the raw data output by the gyroscope may be used to determine orientation angle from the rate of angular change and the accuracy may be significantly reduced when the offset or other sources of noise are not properly compensated.

In particular, it may be desirable to compensate for gyroscope offset and noise that may be a result of power supply instability conditions, vibration or other mechanical-based conditions, stochastic or temporal-based conditions, temperature or thermal-based instability conditions. Conventional techniques for estimating gyroscope offset suffer from certain disadvantages. For example, linear or quadratic curve fitting algorithms typically require static conditions to be implemented effectively. Further, state estimation techniques such as the use of a Kalman filter require external reference sources, such as a Global Navigation Satellite System (GNSS) that involves additional circuitry and power consumption in addition to being subject to poor reception in many environmental conditions. Still further, thermally stabilizing a gyroscope requires use of cooling and/or heating elements along with control and feedback circuitry and the attendant resource cost.

Accordingly, it would be desirable to provide systems and methods to compensate for gyroscope offset. For example, it would be desirable to compensate for power supply, stochastic and/or temperature disturbances. Likewise, it would be desirable to compensate for noise from mechanical vibration or user dynamics. Further, it would be desirable to apply these techniques alone or in combination. As described in the following materials, this disclosure satisfies these and other goals.

### SUMMARY

As will be described in detail below, this disclosure includes a method to compensate for a gyroscope offset of a gyroscope integrated with a portable device including the steps of obtaining an input gyroscope signal, supplying a constant value reference signal, applying a first filter having a bias weight to the constant value reference signal to provide a first adaptive cancellation signal and mixing the first adaptive cancellation signal with the gyroscope signal to provide an integrated gyroscope signal, wherein the bias weight of the first filter is based at least in part on an error signal obtained from the integrated gyroscope signal.

In one aspect, the method may also include detecting motion of the portable device corresponding to use dynamics that exceeds a first threshold, obtaining a signal from a motion sensor integrated with the portable device, deriving a noise signal from the motion sensor signal that is frequency correlated with the gyroscope signal, applying a second filter to the noise signal to provide a second adaptive cancellation signal and mixing the second adaptive cancellation signal with a gyroscope signal to provide the input gyroscope signal to be mixed with the first adaptive cancellation signal, wherein filter coefficients of the second filter that are based at least in part on an error signal obtained from the input gyroscope signal.

In one aspect, the method may also include detecting a vibratory motion of the portable device that exceeds a second threshold, applying a discrete wavelet transform function to decompose a gyroscope signal into a selected number of resolution levels, applying a thresholding function to wavelet coefficients, processing the decomposed gyroscope signal with the wavelet coefficients and applying an inverse wavelet transform to the processed decomposed gyroscope signal to provide the input gyroscope signal to be mixed with the first adaptive cancellation signal.

This disclosure also includes a portable device having a gyroscope integrated with the portable device outputting a signal and a noise compensator that may obtain an input gyroscope signal, supply a constant value reference signal, apply a first filter having a bias weight to the constant value reference signal to provide a first adaptive cancellation signal and mix the first adaptive cancellation signal with the gyroscope signal to provide an integrated gyroscope signal, wherein the bias weight of the first filter is based at least in part on an error signal obtained from the integrated gyroscope signal.

In one aspect, the device may also have an accelerometer integrated with the portable device outputting a signal, wherein the noise compensator may detect motion of the portable device corresponding to use dynamics that exceeds a first threshold, derive a noise signal from the accelerometer signal that is frequency correlated with the gyroscope signal, apply a second filter to the noise signal to provide a second adaptive cancellation signal and mix the second adaptive cancellation signal with a gyroscope signal to provide the input gyroscope signal to be mixed with the first adaptive cancellation signal, wherein filter coefficients of the second filter that are based at least in part on an error signal obtained from the input gyroscope signal.

In one aspect, the noise compensator may also detect a vibratory motion of the portable device that exceeds a second threshold, apply a discrete wavelet transform function to decompose a gyroscope signal into a selected number of resolution levels, apply a thresholding function to wavelet coefficients, process the decomposed gyroscope signal with the wavelet coefficients and apply an inverse wavelet transform to the processed decomposed gyroscope signal to provide the input gyroscope signal to be mixed with the first adaptive cancellation signal.

### BRIEF DESCRIPTION OF THE DRAWINGS

FIG. 1 is schematic diagram of a portable device that compensates for gyroscope offset according to an embodiment.

FIG. 2 is flowchart showing a routine that compensates for gyroscope offset in a portable device according to an embodiment.

FIG. 3 is schematic diagram of a technique for reducing noise in a gyroscope signal according to an embodiment.

FIG. 4 is schematic diagram of a technique for adaptively cancelling noise in a gyroscope signal according to an embodiment.

FIG. 5 is schematic diagram of a technique for adaptively compensating for gyroscope offset in a gyroscope signal according to an embodiment.

FIGS. 6A-C are graphic representations of accelerometer signals and reduced noise gyroscope signals according to an embodiment.

FIGS. 7A-D are graphic representations of gyroscope signals, reduced noise gyroscope signals and estimated offset of the gyroscope signals according to an embodiment.

FIG. 8 is a graphic representation of integrated gyroscope signals compensated for offset according to an embodiment.

### DETAILED DESCRIPTION

At the outset, it is to be understood that this disclosure is not limited to particularly exemplified materials, architectures, routines, methods or structures as such may vary. Thus, although a number of such options, similar or equivalent to those described herein, can be used in the practice or embodiments of this disclosure, the preferred materials and methods are described herein.

It is also to be understood that the terminology used herein is for the purpose of describing particular embodiments of this disclosure only and is not intended to be limiting.

The detailed description set forth below in connection with the appended drawings is intended as a description of exemplary embodiments of the present disclosure and is not intended to represent the only exemplary embodiments in which the present disclosure can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the specification. It will be apparent to those skilled in the art that the exemplary embodiments of the specification may be practiced without these specific details. In some instances, well known structures and devices are shown in block diagram form in order to avoid obscuring the novelty of the exemplary embodiments present herein.

For purposes of convenience and clarity only, directional terms, such as top, bottom, left, right, up, down, over, above, below, beneath, rear, back, and front, may be used with respect to the accompanying drawings or chip embodiments. These and similar directional terms should not be construed to limit the scope of the disclosure in any manner.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the exemplary wireless communications devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor. For example, a carrier wave may be employed to carry computer-readable electronic data such as those used in transmitting and receiving electronic mail or in accessing a network such as the Internet or a local area network (LAN). Of course, many modifications may be made to this configuration without departing from the scope or spirit of the claimed subject matter.

The various illustrative logical blocks, modules, circuits and instructions described in connection with the embodiments disclosed herein may be executed by one or more processors, such as one or more motion processing units (MPUs), digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an MPU and a microprocessor, a plurality of microprocessors, one or more microprocessor in conjunction with an MPU core, or any other such configuration.

Unless defined otherwise, all technical and scientific terms used herein have the same meaning as commonly understood by one having ordinary skill in the art to which the disclosure pertains.

Finally, as used in this specification and the appended claims, the singular forms “a,” “an” and “the” include plural referents unless the content clearly dictates otherwise.

According to this disclosure, a portable device having a gyroscope may utilize one or more techniques to compensate for offset or other sources of noise in the gyroscope signal. For example, a low frequency adaptive noise cancellation technique may be used to compensate for gyroscope offset. Further, an adaptive noise cancellation technique may be used to reduce noise that may have a periodic motion component, such as noise associated with user dynamics. Still further, a discrete wavelet transform (DWT) technique may be applied to reduce noise in a gyroscope signal that results from vibration or other mechanical sources. Each of these aspects may be performed alone or in any combination depending on the embodiment.

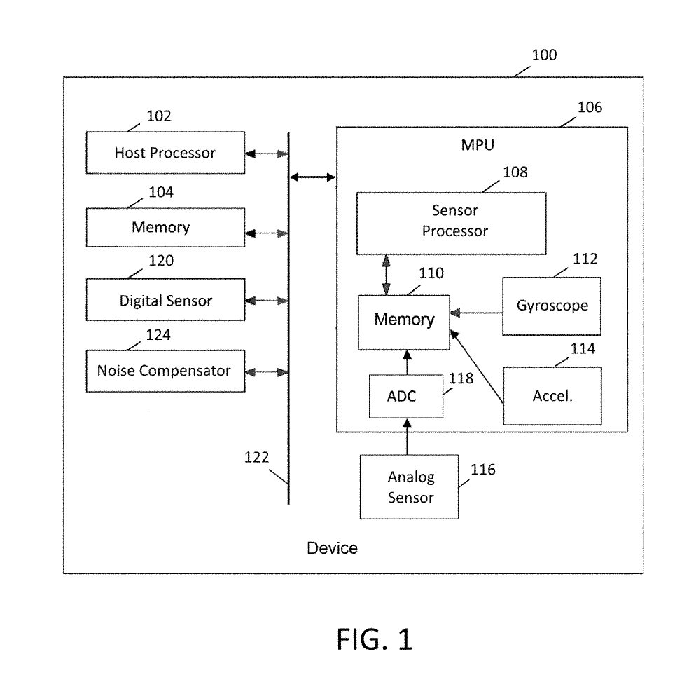

In some embodiments, it will be recognized that the exemplary architecture depicted in FIG. 1 may allow the calibration of one or more internal sensors to be performed using MPU 102 and may not require involvement of host processor 104 and/or host memory 106. Such an embodiment may be termed a self-calibrating MPU and, as described above, may be implemented with internal sensor or sensors 116 on a single substrate. Moreover, as will be described below, the calibration techniques may be implemented using computationally efficient algorithms to reduce processing overhead and power consumption.

Details regarding one embodiment of a portable device 100 including features of this disclosure are depicted as high level schematic blocks in FIG. 1. As will be appreciated, device 100 may be implemented as a device or apparatus, such as a handheld or wearable device that can be moved in space by a user and its motion, location and/or orientation in space therefore sensed. For example, such a portable device may be a mobile phone (e.g., cellular phone, a phone running on a local network, or any other telephone handset), tablet, personal digital assistant (PDA), video game player, video game controller, navigation device, wearable device (e.g., glasses, watch, belt clip), fitness tracker, virtual or augmented reality equipment, mobile internal device (MID), personal navigation device (PND), digital still camera, digital video camera, binoculars, telephoto lens, portable music, video or media player, remote control, or other handheld device, or a combination of one or more of these devices. However, the techniques of this disclosure may also be applied to other types of devices that are not handheld, including autonomous or piloted vehicles whether land-based, aerial, or underwater vehicles, or equipment that may be used with such vehicles. As an illustration only and without limitation, the vehicle may be a drone, also known as an unmanned aerial vehicle (UAV).

As shown, device 100 includes a host processor 102, which may be one or more microprocessors, central processing units (CPUs), or other processors to run software programs, which may be stored in memory 104, associated with the functions of device 100. Multiple layers of software can be provided in memory 104, which may be any combination of computer readable medium such as electronic memory or other storage medium such as hard disk, optical disk, etc., for use with the host processor 102. For example, an operating system layer can be provided for device 100 to control and manage system resources in real time, enable functions of application software and other layers, and interface application programs with other software and functions of device 100. Similarly, different software application programs such as menu navigation software, games, camera function control, navigation software, communications software, such as telephony or wireless local area network (WLAN) software, or any of a wide variety of other software and functional interfaces can be provided. In some embodiments, multiple different applications can be provided on a single device 100, and in some of those embodiments, multiple applications can run simultaneously.

Device 100 may also include integrated motion processing unit (MPU™) 106 featuring sensor processor 108, memory 110 and gyroscope 112, which may be configured to measure angular velocity along one or more orthogonal axes. Memory 110 may store algorithms, routines or other instructions for processing data output by gyroscope 112 and/or other sensors as described below using logic or controllers of sensor processor 108, as well as storing raw data and/or motion data output by gyroscope 112 or other sensors. In this embodiment, MPU 106 also includes accelerometer 114 configured to measure linear acceleration along one or more orthogonal axes. Device 100 may optionally include one or more other sensors for measuring motion of device 100 in space, such as a magnetometer or barometer. Depending on the configuration, MPU 106 measures one or more axes of rotation and/or one or more axes of acceleration of the device. In one embodiment, at least some of the motion sensors are inertial MEMS-based sensors. In one aspect, three gyroscopes and three accelerometers may be employed, such that a sensor fusion operation performed by sensors processor 108 or other processing resources of device 100 combines data from gyroscope 112 and accelerometer 114 to provide a six axis determination of motion. As desired, gyroscope 112 and accelerometer 114 may be implemented using MEMS to be integrated with MPU 106 in a single package. Exemplary details regarding suitable configurations of host processor 102 and MPU 106 may be found in co-pending, commonly owned U.S. patent application Ser. Nos. 11/774,488, filed Jul. 6, 1007, and 12/106,921, filed Apr. 11, 1008, which are hereby incorporated by reference in their entirety. Further, MPU 106 may be configured as a sensor hub by aggregating sensor data from additional processing layers as described in co-pending, commonly owned U.S. patent application Ser. No. 14/480,364, filed Sep. 8, 1014, which is also hereby incorporated by reference in its entirety. Suitable implementations for MPU 106 in device 100 are available from InvenSense, Inc. of Sunnyvale, Calif.

Device 100 may also include other sensors as desired. As shown, analog sensor 116 may provide output to analog to digital converter (ADC) 118 within MPU 106. Alternatively or in addition, data output by digital sensor 120 may be communicated over bus 122 to sensor processor 106 or other processing resources in device 100. Analog sensor 116 and digital sensor 120 may provide additional sensor data about the environment surrounding device 100. For example, temperature and/or relative humidity sensors may be used to make suitable adjustments to the data from gyroscope 112 during normal operation or during calibration as desired. In other embodiments, information regarding environmental variables affecting device 100 may be obtained from any suitable source, including externally. For example, information regarding other environmental variables may be included with the reference pressure information. Other sensors, such as one or more magnetometers, barometers, infrared sensors, ultrasonic sensors, radio frequency sensors, proximity sensors or other types of sensors can also be provided. In one embodiment, data from a magnetometer measuring along three orthogonal axes may be fused with gyroscope, accelerometer and barometer data to provide a ten axis determination of motion. Although described in the context of one or more sensors being MEMS based, the techniques of this disclosure may be applied to any sensors design or implementation.

In the embodiment shown, host processor 102, memory 104, MPU 106 and other components of device 100 may be coupled through bus 122, which may be any suitable bus or interface, such as a peripheral component interconnect express (PCIe) bus, a universal serial bus (USB), a universal asynchronous receiver/transmitter (UART) serial bus, a suitable advanced microcontroller bus architecture (AMBA) interface, an Inter-Integrated Circuit (I2C) bus, a serial digital input output (SDIO) bus, a serial peripheral interface (SPI) or other equivalent. Depending on the architecture, different bus configurations may be employed as desired. For example, additional buses may be used to couple the various components of device 100, such as by using a dedicated bus between host processor 102 and memory 104. As noted above, multiple layers of software may be employed as desired and stored in any combination of memory 104, memory 110, or other suitable location. For example, a motion algorithm layer can provide motion algorithms that provide lower-level processing for raw sensor data provided from the motion sensors and other sensors. A sensor device driver layer may provide a software interface to the hardware sensors of device 100. Further, a suitable application program interface (API) may be provided to facilitate communication between host processor 102 and MPU 106, for example, to transmit desired sensor processing tasks. Other embodiments may feature any desired division of processing between MPU 106 and host processor 102 as appropriate for the applications and/or hardware being employed. For example, lower level software layers may be provided in MPU 106 and an API layer implemented by host processor 102 may allow communication of the states of application programs as well as sensor commands. Some embodiments of API implementations in a motion detecting device are described in co-pending U.S. patent application Ser. No. 12/106,921, incorporated by reference above.

In the depicted embodiment, device 100 includes noise compensator 124 that may be implemented as any suitable combination of hardware and software to adjust the signal provided by gyroscope 112 account for perturbations that may result from a variety of sources, including power supply instability conditions, vibration or other mechanical-based conditions, user dynamics, stochastic or temporal-based conditions, and/or temperature or thermal-based instability conditions. The operation of noise compensator 124 is described in detail below.

Aspects of noise compensator 124 may be implemented in software, which includes, but is not limited to, application software, firmware, resident software, microcode, etc, and may take the form of a computer program product accessible from a computer-usable or computer-readable medium providing program code for use by or in connection with a computer or any instruction execution system, such as host processor 102, sensor processor 108 or any other processing resources of device 100.

Sensor processor 108 and gyroscope 112 may be formed on different chips, or as shown, may reside on the same chip. A sensor fusion algorithm employed to calculate the orientation of device 100 may be performed externally to sensor processor 108 and MPU 106, such as by host processor 104, or may be performed by MPU 106. A chip may be defined to include at least one substrate typically formed from a semiconductor material. A single chip may be formed from multiple substrates, where the substrates are mechanically bonded to preserve the functionality. A multiple chip includes at least two substrates, wherein the two substrates are electrically connected, but do not require mechanical bonding. A package provides electrical connection between the bond pads on the chip to a metal lead that can be soldered to a PCB. A package typically comprises a substrate and a cover. Integrated Circuit (IC) substrate may refer to a silicon substrate with electrical circuits, typically CMOS circuits. One or more sensors may be incorporated into the package if desired using any suitable technique. In some embodiments, a sensor may be MEMS-based, such that a MEMS cap provides mechanical support for the MEMS structure. The MEMS structural layer is attached to the MEMS cap. The MEMS cap is also referred to as handle substrate or handle wafer. In some embodiments, the first substrate may be vertically stacked, attached and electrically connected to the second substrate in a single semiconductor chip, while in other embodiments, the first substrate may be disposed laterally and electrically connected to the second substrate in a single semiconductor package. In one embodiment, the first substrate is attached to the second substrate through wafer bonding, as described in commonly owned U.S. Pat. No. 7,104,129, which is incorporated herein by reference in its entirety, to simultaneously provide electrical connections and hermetically seal the MEMS devices. This fabrication technique advantageously enables technology that allows for the design and manufacture of high performance, multi-axis, inertial sensors in a very small and economical package. Integration at the wafer-level minimizes parasitic capacitances, allowing for improved signal-to-noise relative to a discrete solution. Such integration at the wafer-level also enables the incorporation of a rich feature set which minimizes the need for external amplification.

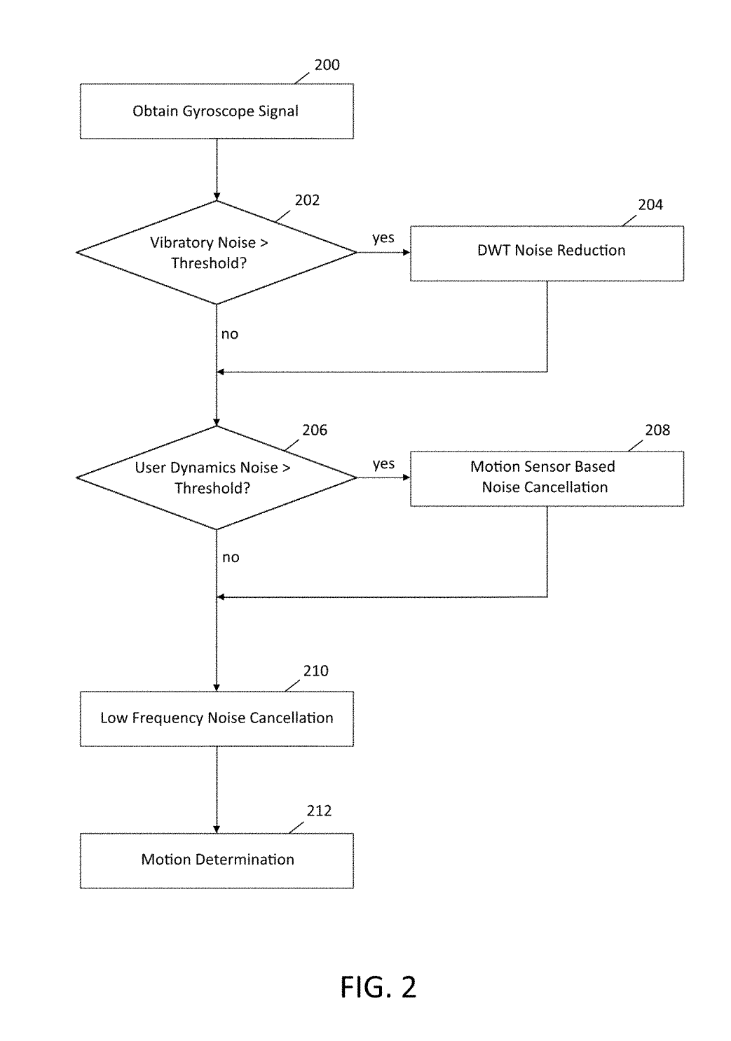

To help illustrate aspects of the operation of noise compensator 124, FIG. 2 depicts a flowchart showing a process for reducing noise in a gyroscope signal according to one embodiment. Beginning with 200, noise compensator 124 may receive an input gyroscope signal, such as from gyroscope 112. In 202, a determination may be made whether the amount of noise in the gyroscope signal corresponding to vibration or other mechanical conditions exceeds a threshold. If so, a DWT process is performed in 204 to reduce the noise and the output is fed to 206. Further details regarding suitable DWT processes are given below. If not, the routine bypasses 204 and proceeds to 206 to determine whether the amount of noise in the gyroscope signal corresponding to user dynamics exceeds a threshold. For example, user dynamics associated with types of locomotion such as walking, running, cycling, rowing may impart a periodic or other characteristic perturbation in the gyroscope signal. If noise corresponding to such user dynamics exceeds the threshold, a motion sensor based adaptive noise cancellation process may be performed in 208 and the output provided to 210. Further details regarding suitable motion sensor based adaptive noise cancellation processes are given below. If not, the routine bypasses 208 and proceeds to 210 for noise compensator 124 to apply a low frequency adaptive noise cancellation process to compensate for gyroscope offset. Further details regarding suitable low frequency adaptive noise cancellation processes are given below. The integrated gyroscope signal output by 210 may then be used in 212 to perform a motion determination for portable device 100. Any suitable use of gyroscope information may be employed, including determining orientation, change in relative orientation, sensor fusion, determining a navigation solution that may include one or more of attitude, position, velocity (or speed), or other similar operations. As noted, each of the processes represented by 204, 208 and 210 may be performed individually or in any desired combination in other embodiments.

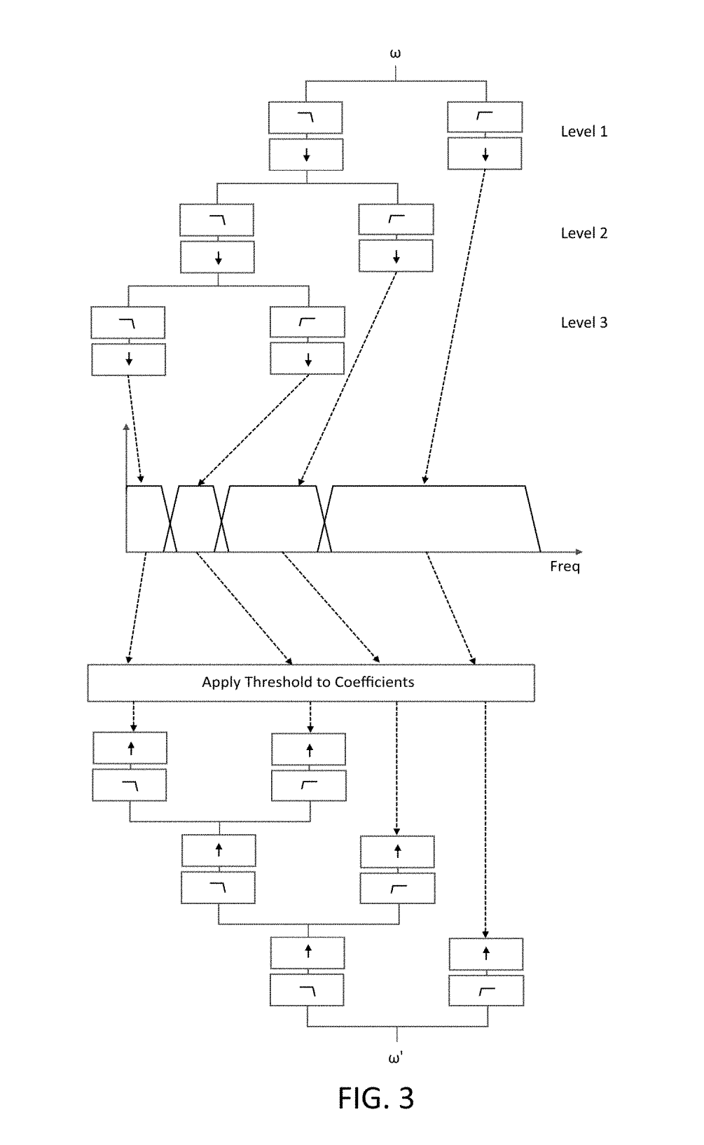

An example of a DWT process to remove noise from a gyroscope signal resulting from vibration or other mechanical conditions is schematically illustrated in FIG. 3. A wavelet lifting technique involving polyphase matrix factorization may be employed to remove noise from the gyroscope signal. As indicated, a DWT function may be applied in an analysis stage to decompose an input gyroscope signal ω into a selected number of resolution levels in frequency and time, such as the three levels indicated in this embodiment. At each level, the input signal is bifurcated using high and low pass filters and then downsampled. In this example, the low frequency branch is bifurcated at each level, however the high frequency branch may be chosen if desired to increase the resolution for a specific frequency range. Once a suitable degree of decomposition has been performed, the wavelet coefficients may be determined for each resolution level. A thresholding function may then be applied to the coefficients to selectively emphasize wavelets corresponding to the gyroscope signal and deemphasize wavelets corresponding to noise. Examples of thresholding functions include soft thresholding which may be employed to smooth the signal or hard thresholding to retail detail. Depending on whether the wavelet coefficients exceed the chosen thresholds, the decomposed gyroscope signal is processed to reduce the amplitude of the corresponding wavelets, by “shrinking” the coefficients. Following the thresholding function, a reconstruction stage performs an Inverse Wavelet Transform (IWT) process. As indicated, the components at each level are upsampled, high and low pass filtered respectively and combined. Once all the resolution levels have been combined, the reconstructed gyroscope signal is ω′ has a reduced amount of noise and may be used to perform a motion determination for device 100, or may be further adjusted by the other techniques of this disclosure. Advantageously, the DWT process may be implemented as a zero phase technique that does not impart a delay in the motion sensor signal.

As noted, the DWT process may be applied to reduce noise that may result from vibration or other mechanical conditions. For example, embodiments of portable device 100 may include a vehicle that is propelled by motor or motors that may cause vibration that affects gyroscope 112. In particular, UAVs may be particularly susceptible to vibration noise and the gyroscope signal in such applications may be significantly enhanced by compensating for this noise source.

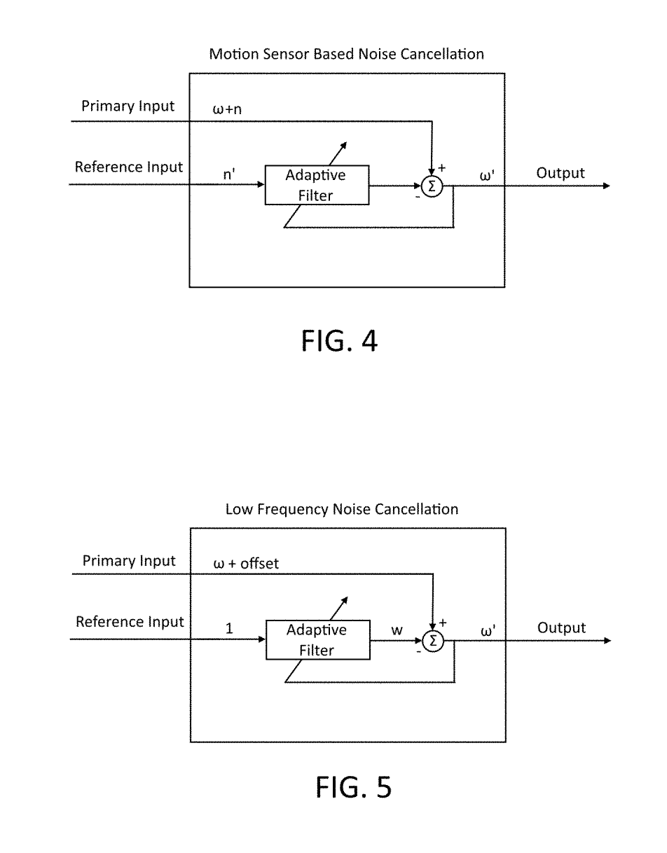

In another aspect, noise compensator 124 may perform a motion sensor based adaptive noise cancellation process on the gyroscope signal. An example of a motion based adaptive noise cancellation process is schematically depicted in FIG. 4. The motion sensor based adaptive noise cancellation has two inputs, a primary input that may be the gyroscope signal, either in the form of the raw output of gyroscope 112 or the output of a DWT process. The input gyroscope signal may be modelled as the desired gyroscope signal, ω, plus a noise component, n, that may result from motion associated with user dynamics as described above or other sources. The reference input, n′, may be derived from a source that is correlated with the noise component n but is uncorrelated with the gyroscope signal. In one embodiment, n′ may be derived from the signal output by accelerometer 114 because it measures only translational motion and is therefore not correlated with the rotational measurements of gyroscope 112. The reference input n′ is then adjusted by the adaptive filer as indicated to output an adaptive cancellation signal that is subtracted from the primary input signal to generate an adjusted gyroscope signal, ω′. Although described in this embodiment in the context of an accelerometer signal, any motion sensor signal having frequencies that correlate with the motion associated with user dynamics may be employed for the reference input, so long as it does not correlate with the rotational movement sensed by gyroscope 112. Further, the adjusted gyroscope signal ω′ functions as an effective error signal for the adaptive filter because minimizing the power of the output through a least squares algorithm provides an adaptive cancellation signal that most closely approximates noise n. The adaptive filter may employ any suitable least squares algorithm as desired. Further, as with the DWT process, the motion sensor based adaptive noise cancellation employs a zero phase filter that does not impart a delay in the gyroscope signal.

Noise compensator 124 may also perform a low frequency adaptive noise cancellation process on the gyroscope signal, as schematically depicted in FIG. 5. The low frequency adaptive noise cancellation also has two inputs, including a primary input that may be the gyroscope signal, and may be in the form of the raw output of gyroscope 112, the output of a DWT process or the corrected signal resulting from motion sensor based adaptive noise cancellation. At this stage, the input gyroscope signal may be modelled as the desired gyroscope signal, ω, plus offset. As noted above, the offset may be attributed to power supply instability conditions, stochastic or temporal-based conditions and/or temperature or thermal-based instability conditions. By employing adaptive filtering techniques, the time-varying aspects of such offsets may be effectively compensated. The reference input may be a constant value, such as 1 as indicated in this embodiment. The reference input is adjusted by applying coefficient determined by the adaptive filter using a least squares algorithm to output an adaptive cancellation signal that is subtracted from the primary input signal to generate an integrated gyroscope signal, ω′, that is compensated for offset. Again, the integrated gyroscope signal ω′ functions as an effective error signal for the adaptive filter because minimizing the power of the output through a least squares algorithm provides an adaptive cancellation signal that most closely approximates the DC bias or offset. The adaptive filter may employ any suitable least squares algorithm as desired. It will be appreciated in this context that the low frequency adaptive noise cancellation process provides a function that corresponds to a notch filter center at zero frequency. Correspondingly, the bias weight established by the filter coefficients adaptively locks on to the gyroscope offset, and is continually updated to match the DC level to be cancelled that results from gyroscope drift. As with the other techniques of this disclosure, the low frequency adaptive noise cancellation employs a zero phase filter that does not impart a delay in the gyroscope signal.

Optionally, performance of the low frequency adaptive noise cancellation process may be enhanced by seeding the least squares algorithm with an initial estimate of the gyroscope offset. This may be obtained from a previous run, expected performance or any other suitable source. In one embodiment, offset may be estimated during a period that is detected to be sufficiently static. Additionally, a DWT process may be performed to reduce noise in the gyroscope signal prior to estimating the offset that may then be fed as a starting point for the low frequency adaptive noise cancellation process.

Since both the motion sensor based adaptive noise cancellation process and the low frequency adaptive noise cancellation process employ an implementation of a least squares algorithm to determine the filter coefficients that are applied to generate the cancelling signal, either or both may benefit from suitable adjustments to the parameters of the algorithm. For example, a convergence factor μ may be selected to achieve a desired performance characteristic. Notably, a convergence factor may be employed to govern the amount of change made to the filter coefficients with each adjustment. When desirable to decrease the time to convergence, a relatively large factor may be used. However, although convergence time may be decreased, there may be a correspondingly large variance about the mean, reducing the accuracy of the cancellation. Accordingly, a relatively small convergence factor may be used to decrease the amount of variance about the mean to increase the accuracy. Since a lower convergence factor is associated with smaller adjustments to the coefficients, the time to convergence may be increased. In some embodiments, it may be desirable to exploit these characteristics by setting a larger convergence factor during initial operation of the filter to obtain a rapid cancellation of the offset, followed by switching to a smaller convergence factor to subsequently provide a more accurate cancellation. It will be appreciated that other adjustments to the least squares algorithm parameters may be made as desired.

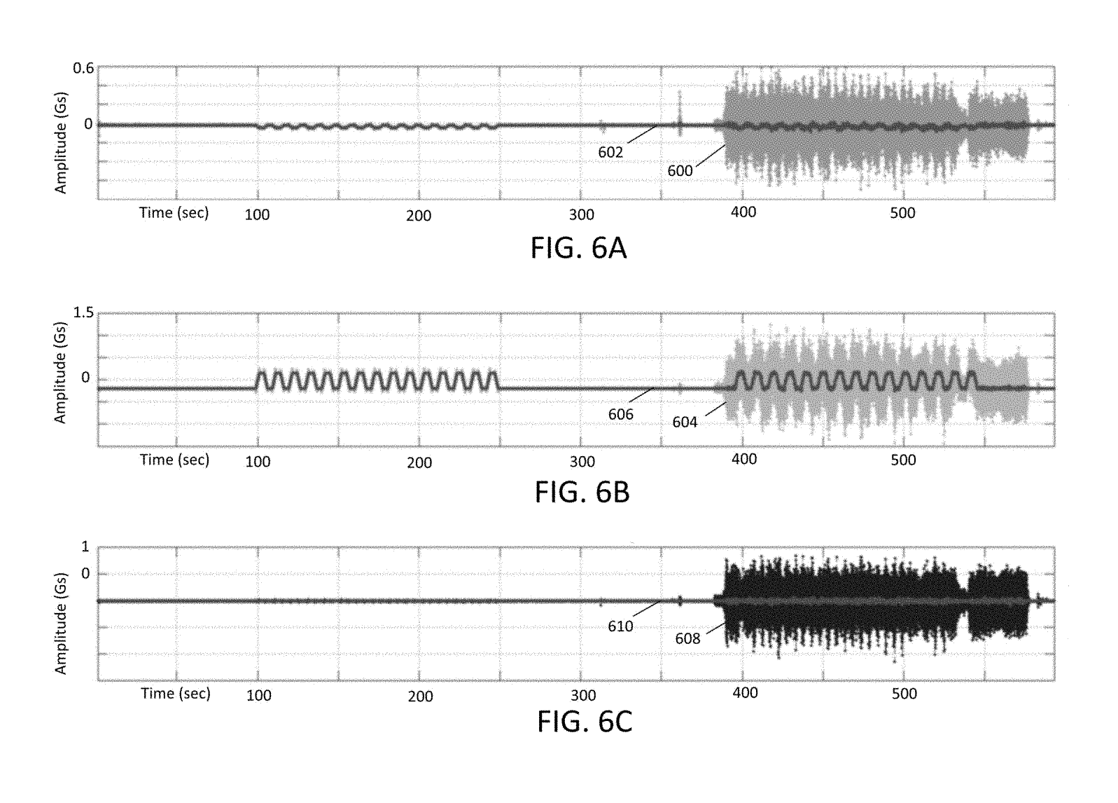

To validate the techniques of this disclosure, tests have been conducted under conditions that emulate real world conditions. A UAV drone was operated under full rotor speed while strapped to a mechanical gimbal that was used to inject signals to an accelerometer and a gyroscope integrated with the drone. The signals from the motion sensors were logged and the results are depicted in FIGS. 6-8. Acceleration and rotation were induced to the drone by movement of the gimbal of alternating cycles of 2 seconds a rate of +10°/s and then at −10°/s with an intervening motionless period to provide ten minutes of motion sensor data.

The signal output by the accelerometer and the corresponding de-noised signal following application of a DWT process are shown in FIGS. 6A-C, with the x-axis signals shown in FIG. 6A, the y-axis signal shown in FIG. 6B and the z-axis signal shown in FIG. 6C. In particular, trace 600 is the raw x-axis accelerometer signal and trace 602 is the DWT de-noised signal in FIG. 6A, trace 604 is the raw y-axis accelerometer signal and trace 606 is the DWT de-noised signal in FIG. 6B and trace 608 is the raw z-axis accelerometer signal and trace 610 is the DWT de-noised signal in FIG. 6C.

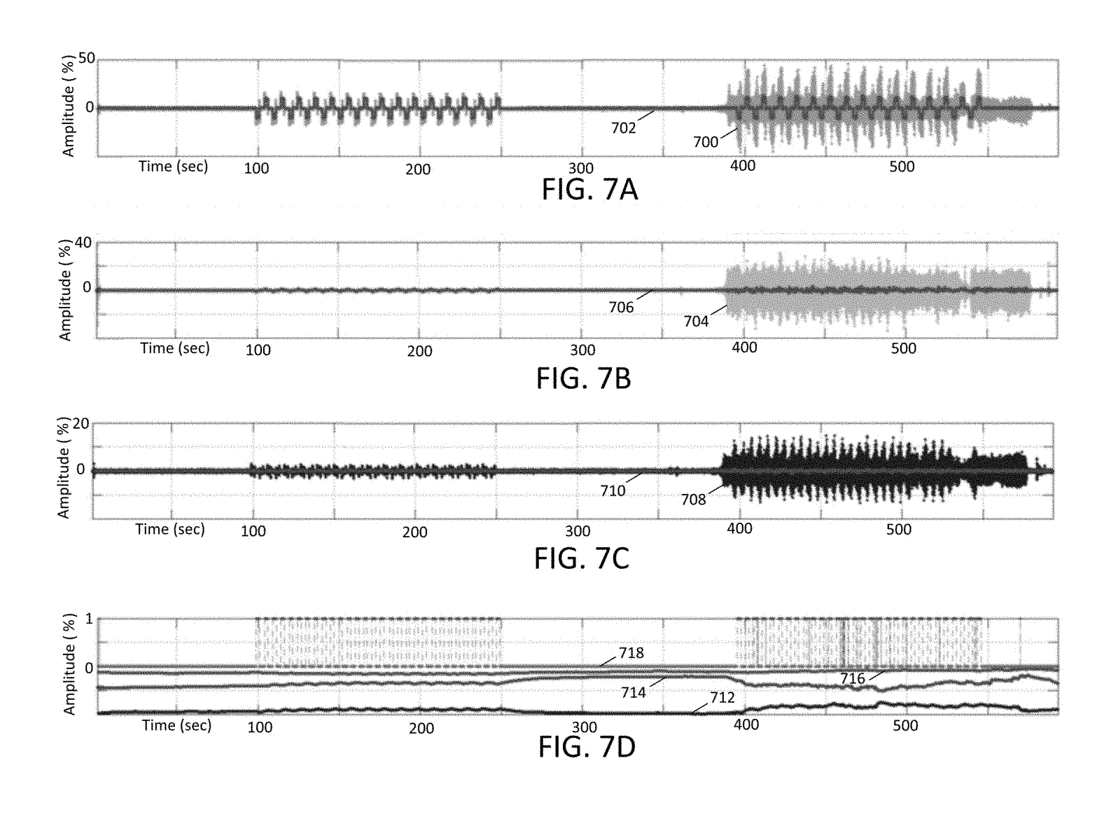

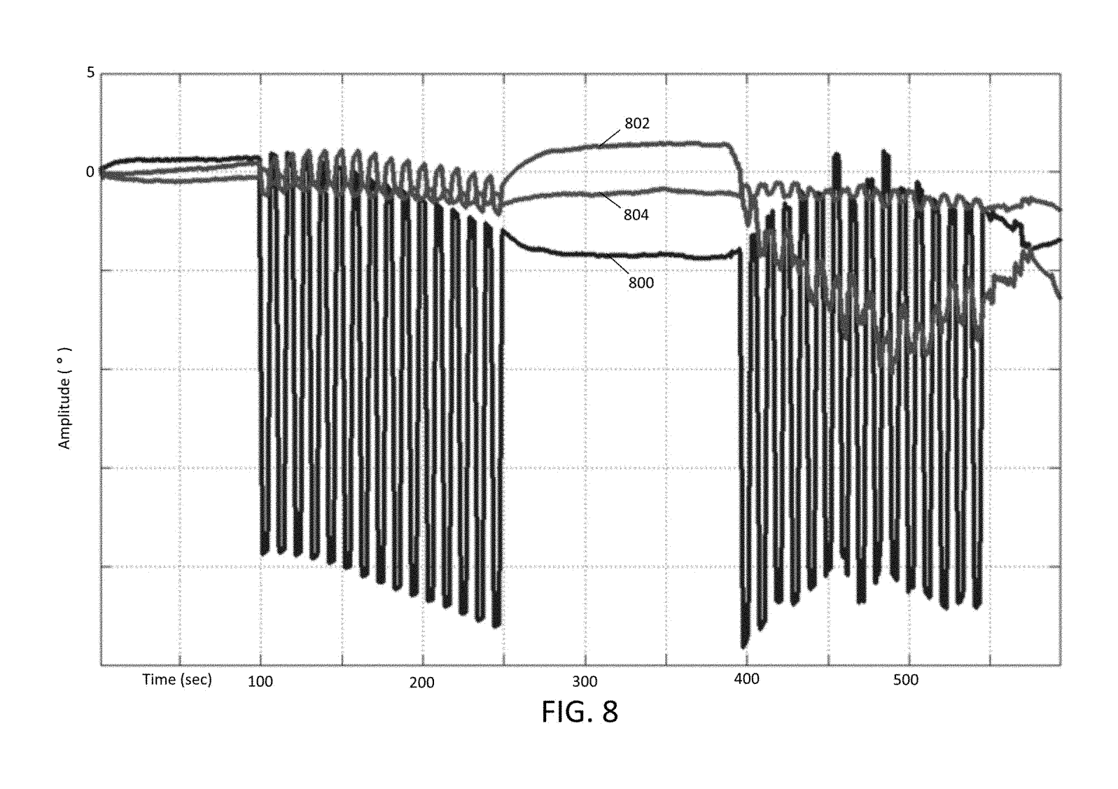

Likewise, gyroscope signals are shown in FIGS. 7A-D, in which trace 700 is the raw x-axis gyroscope signal and trace 702 is the DWT de-noised signal in FIG. 7A, trace 704 is the raw y-axis gyroscope signal and trace 706 is the DWT de-noised signal in FIG. 7B and trace 708 is the raw z-axis gyroscope signal and trace 710 is the DWT de-noised signal in FIG. 7C. The de-noised gyroscope signals were then fed to a low frequency adaptive noise cancellation process using the techniques described above to generate a cancellation signal corresponding to the gyroscope offset. As shown in FIG. 7D, the estimated offset for the x-axis is represented by trace 712, the estimated offset for the y-axis is represented by trace 714 and the estimated offset for the z-axis is represented by trace 716. The gyroscope dynamics are represented by trace 718.

Next, the integrated gyroscope signal following de-noising and compensation for offset by low frequency adaptive noise cancellation are depicted in FIG. 8, with the x-axis signal represented by trace 800, the y-axis signal represented by trace 802 and the z-axis signal represented by trace 804. As shown, the is a residual offset error of approximately 5° at the end of the ten minute test, which corresponds to an error rate in the offset cancellation of less than 0.01°/s.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the present invention.

What is claimed is:

1. A method to compensate for a gyroscope offset of a gyroscope integrated with a portable device comprising:
obtaining an input gyroscope signal;
supplying a constant value reference signal;
applying a first filter having a bias weight to the constant value reference signal to provide a first adaptive cancellation signal; and
mixing the first adaptive cancellation signal with the gyroscope signal to provide an integrated gyroscope signal,
wherein the bias weight of the first filter is based at least in part on an error signal obtained from the integrated gyroscope signal.

2. The method of claim 1, wherein the bias weight for the first filter is derived by applying a least mean squares algorithm to the gyroscope error signal.

3. The method of claim 1, wherein the bias weight represents a DC bias of the gyroscope signal.

4. The method of claim 1, wherein the first filter is a notch filter centered at zero frequency.

5. The method of claim 1, wherein the first filter is a zero phase filter.

6. The method of claim 1, further comprising adjusting a convergence factor of the first filter during a subsequent iteration.

7. The method of claim 6, wherein adjusting the convergence factor comprises reducing the convergence factor.

8. The method of claim 1, further comprising:
detecting motion of the portable device corresponding to user dynamics that exceeds a first threshold;
obtaining a signal from a motion sensor integrated with the portable device;
deriving a noise signal from the motion sensor signal that is frequency correlated with the gyroscope signal;
applying a second filter to the noise signal to provide a second adaptive cancellation signal; and
mixing the second adaptive cancellation signal with a gyroscope signal to provide the input gyroscope signal to be mixed with the first adaptive cancellation signal,
wherein filter coefficients of the second filter that are based at least in part on an error signal obtained from the input gyroscope signal.

9. The method of claim 8, wherein the filter coefficients of the second filter are selected to minimize a power of the input gyroscope signal.

10. The method of claim 8, wherein the motion sensor is an accelerometer.

11. The method of claim 1, further comprising:
detecting a vibratory motion of the portable device that exceeds a second threshold;
applying a discrete wavelet transform function to decompose a gyroscope signal into a selected number of resolution levels;
applying a thresholding function to wavelet coefficients;
processing the decomposed gyroscope signal with the wavelet coefficients; and
applying an inverse wavelet transform to the processed decomposed gyroscope signal to provide the input gyroscope signal to be mixed with the first adaptive cancellation signal.

12. The method of claim 11, wherein the thresholding function is based at least in part on estimated vibratory conditions.

13. The method of claim 11, further comprising adjusting the second threshold based at least in part on detecting the portable device is in a static condition.

14. The method of claim 10, further comprising:
obtaining a signal from a motion sensor integrated with the portable device;
applying a discrete wavelet transform function to decompose the motion sensor signal into a selected number of resolution levels;
applying a thresholding function to wavelet coefficients;
processing the decomposed motion sensor signal with the wavelet coefficients; and
applying an inverse wavelet transform to the processed decomposed accelerometer signal to provide an adjusted motion sensor signal.

15. The method of claim 14, further comprising:
detecting motion of the portable device corresponding to user dynamics that exceeds a first threshold;
deriving a noise signal from the adjusted motion sensor signal that is frequency correlated with the gyroscope signal;
applying a second filter to the noise signal to provide a second adaptive cancellation signal; and
mixing the second adaptive cancellation signal with a gyroscope signal to provide the input gyroscope signal to be mixed with the first adaptive cancellation signal,
wherein filter coefficients of the second filter that are based at least in part on an error signal obtained from the input gyroscope signal.

16. A portable device comprising:
a gyroscope integrated with the portable device outputting a signal; and
a noise compensator configured to:
obtain an input gyroscope signal;
supply a constant value reference signal;
apply a first filter having a bias weight to the constant value reference signal to provide a first adaptive cancellation signal; and
mix the first adaptive cancellation signal with the gyroscope signal to provide an integrated gyroscope signal,
wherein the bias weight of the first filter is based at least in part on an error signal obtained from the integrated gyroscope signal.

17. The portable device of claim 16, further comprising an accelerometer integrated with the portable device outputting a signal, wherein the noise compensator is further configured to:
detect motion of the portable device corresponding to user dynamics that exceeds a first threshold;
derive a noise signal from the accelerometer signal that is frequency correlated with the gyroscope signal;
apply a second filter to the noise signal to provide a second adaptive cancellation signal; and
mix the second adaptive cancellation signal with a gyroscope signal to provide the input gyroscope signal to be mixed with the first adaptive cancellation signal,
wherein filter coefficients of the second filter that are based at least in part on an error signal obtained from the input gyroscope signal.

18. The portable device of claim 16, wherein the noise compensator is further configured to:
detect a vibratory motion of the portable device that exceeds a second threshold;
apply a discrete wavelet transform function to decompose a gyroscope signal into a selected number of resolution levels;
apply a thresholding function to wavelet coefficients;
process the decomposed gyroscope signal with the wavelet coefficients; and
apply an inverse wavelet transform to the processed decomposed gyroscope signal to provide the input gyroscope signal to be mixed with the first adaptive cancellation signal.

19. The portable device of claim 18, further comprising an accelerometer integrated with the portable device outputting a signal, wherein the noise compensator is further configured to:
apply a discrete wavelet transform function to decompose the accelerometer signal into a selected number of resolution levels;
apply a thresholding function to wavelet coefficients;
process the decomposed accelerometer signal with the wavelet coefficients; and
apply an inverse wavelet transform to the processed decomposed accelerometer signal to provide an adjusted accelerometer signal.

20. The portable device of claim 19, wherein the noise compensator is further configured to:
detect a periodic motion of the portable device that exceeds a first threshold;
derive a noise signal from the adjusted accelerometer signal that is frequency correlated with the gyroscope signal;
apply a second filter to the noise signal to provide a second adaptive cancellation signal; and
mix the second adaptive cancellation signal with a gyroscope signal to provide the input gyroscope signal to be mixed with the first adaptive cancellation signal,
wherein filter coefficients of the second filter that are based at least in part on an error signal obtained from the input gyroscope signal.
